(19) United States
(12) Patent Application Publication
(10) Pub. No.: US 2024/0052156 A1
(43) Pub. Date: Feb. 15, 2024

(54) Polyvinyl Alcohol Fibres and Meltblown Fibrous Products

(71) Applicant: Aquapak IP Limited, Birmingham (GB)

(72) Inventors: John Williams, Chirbury (GB); Sian Griffiths, Glan Conwy (GB); Robert Ashworth, Colwyn Bay (GB); Jack Eaton, Leeds (GB)

(21) Appl. No.: 18/233,008

(22) Filed: Aug. 11, 2023

(30) Foreign Application Priority Data
Aug. 13, 2022 (EP) 22190327.1
Aug. 13, 2022 (EP) 22190328.9
Aug. 13, 2022 (EP) 22190330.5
Aug. 13, 2022 (EP) 22190331.3

(51) Int. Cl. C08L 29/04; D04H 1/4309; D04H 1/56; D01D 5/084; D01F 6/14; D01F 1/02; D01D 5/098; D04H 3/007; D04H 3/16

(52) U.S. Cl. CPC C08L 29/04; D04H 1/4309; D04H 1/56; D01D 5/084; D01F 6/14; D01F 1/02; D01D 5/0985; D04H 3/007; D04H 3/16; C08L 2205/025; C08L 2203/12; D10B 2321/06; D10B 2505/04; D10B 2509/00

(57) ABSTRACT

This invention relates to polyvinyl alcohol fibers, methods of making polyvinyl alcohol fibres and products manufactured from polyvinyl alcohol fibers. The invention relates particularly but not exclusively to products comprising meltblown polyvinyl alcohol fibers, methods of making meltblown polyvinyl alcohol fibres and products incorporating such fibers.

### CROSS-REFERENCE TO RELATED APPLICATION(S)

This application claims priority under 35 USC § 119(a) to EP Patent Application No. 22190328.9, filed Aug. 13, 2022, EP Patent Application No. 22190330.5, filed Aug. 13, 2022, EP Patent Application No. 22190331.3, filed Aug. 13, 2022, and EP Patent Application No. 22190327.1, filed Aug. 13, 2022, which are hereby incorporated by reference in their entirety for all purposes.

### TECHNICAL FIELD

This invention relates to polyvinyl alcohol fibers, methods of making polyvinyl alcohol fibers and products manufactured from polyvinyl alcohol fibers. The invention relates particularly but not exclusively to products comprising meltblown polyvinyl alcohol fibers, methods of making meltblown polyvinyl alcohol fibers and products incorporating such fibers.

### BACKGROUND

Polyvinyl alcohol has many advantages in comparison to polymers which are traditionally used for manufacture of non-woven fiber products. Polyvinyl alcohol is soluble in water, particularly when heated, facilitating reclamation, recycling and environmental degradation.

Polyvinyl alcohol is manufactured by hydrolysis of homopolymer or co-polymers of polyvinyl acetate. Polyvinyl alcohol manufactured by partial or complete hydrolysis of homopolymeric polyvinyl acetate is referred to as homopolymeric polyvinyl alcohol. The degree of hydrolysis determines the properties of the resultant polymer. Co-polymeric polyvinyl alcohols or homopolymeric polyvinyl alcohol with a low degree (LD) of hydrolysis are easy to process but have inferior mechanical and chemical properties. Homopolymeric polyvinyl alcohol with a high degree (HD) of hydrolysis, for example 85% or greater, has superior properties but is not processable without degradation under conditions using apparatus employed for manufacture of polyolefin non-woven fibers.

Polyvinyl alcohol is soluble in water and fibers have traditionally been made by solution spinning methods using polyvinyl alcohol with a low degree (LD) of hydrolysis. In order to enhance water resistance, thermal e.g., hot drawing and chemical e.g., acetylation steps have been required.

WO2017/046361 discloses a method for manufacture of processable polyvinyl alcohol having a degree of hydrolysis of 98% or greater. WO2022/008521 discloses a method for manufacture of processable polyvinyl alcohol having a degree of hydrolysis in the range of 93% to 98% or more. WO2022/008516 discloses a method for manufacture of plasticized polyvinyl alcohol having a degree of hydrolysis of 93% to 98% or more.

### SUMMARY

According to a first aspect of the present invention, a method of manufacture of a nonwoven product comprising polyvinyl alcohol fibers is provided. The method comprises the steps of providing a polyvinyl alcohol composition comprising homopolymeric polyvinyl alcohol having a degree of hydrolysis of 88% to 98% or greater and a weight average molecular weight in the range from 14,000 to 35,000; a plasticizer selected from the group consisting of: diglycerol, triglycerol, fructose, ribose, xylose, D-mannitol, triacetin, pentaerythritol, dipentaerythritol, methyl pentanediol, 1,2-propanediol, 1,4-butanediol, 2-hydroxy-1,3-propanediol, 3-methyl-1,3-butanediol, 3,3-dimethyl-1,2-butanediol, polyethylene glycol 300, polyethylene glycol 400, alkoxylated polyethylene glycol, caprolactam, tricyclic trimethylolpropane formal, rosin esters, erucamide, and mixtures thereof; and an optional stabilizer selected from the group consisting of: sodium stearate, potassium oleate, sodium benzoate, calcium stearate, stearic acid, dimethyl pentane diol, propionic acid and mixtures thereof; melting the composition at a temperature from 190° C. to 240° C. to form a molten polymer; wherein the molten polymer is meltblown by the steps of: extrusion of the molten polymer through a die having a spinneret to form molten fibers of the polymer; the fibers being blown from the die and attenuated by a flow of heated air to form attenuated molten fibers, the attenuated fibers being deposited on a moving collector and allowed to solidify to form a melt blown nonwoven fiber web.

According to a second aspect of the present invention there is provided meltblown homopolymeric polyvinyl alcohol fiber having a degree of hydrolysis of 88 wt % to 98 wt % or greater. The fiber may be manufactured in accordance with the first aspect of the present invention.

According to a third aspect of the present invention, there is provided a meltblown non-woven fiber product comprising fibers of homopolymeric polyvinyl alcohol having a degree of hydrolysis of 88 wt % to 98 wt % or greater. The product may be made in accordance with the method of the first aspect of the present invention.

### BRIEF DESCRIPTION OF THE DRAWINGS

FIG. 1 is a diagrammatic view of meltblowing apparatus in accordance with this invention; and

FIG. 2 is a cross sectional view of the die of the apparatus shown in FIG. 1.

### DETAILED DESCRIPTION

Melt blowing is a one step process which transforms a melt-processable polymer, particularly polyvinyl alcohol compositions of this invention into non-woven fabric. Pellets of the polymer may be melted and the melt forced by spin pumps through spinnerets containing multiple small orifices. The extruded polymer strands are attenuated just after the die using streams of hot air. The attenuated filaments are subsequently laid down on a collector to form a melt blown web, thus forming a self-bonded melt blown web composed of fine filaments of the polyvinyl alcohol composition. Melt blown non-woven fabrics are characterized as having very fine filaments, typically in the range 1 to 5 μm.

For meltblown applications, the degree of hydrolysis may be 90-95%, preferably 93-95%. For meltblown applications, the molecular weight of the homopolymeric polyvinyl alcohol may be in the range from 14,000 to 22,000, for example, 15,000 to 20,000, for example 16,000 to 20,000.

Molecular weights in this specification are weight average molecular weights and are measured using conventional liquid chromatographic techniques.

In embodiments, the composition may be melted at a temperature from 220° C. to 240° C. The polyvinyl alcohol composition of this invention may have a melt flow index (MFI) of 30 to 80 g/10 min, for example 50 to 75 g/10 min, for example 70 to 75 g/10 min. Melt flow indices referred to in this specification are determined at 230° C. using a weight of 10 kg by conventional techniques.

The polyvinyl alcohol composition of this invention is stable at the temperature at which it is melted and extruded. Polyvinyl alcohol, not containing a plasticizer and stabilizer as disclosed herein, particularly the homopolymer having a high degree of hydrolysis, may be liable to decompose at the temperatures required for melting and extrusion processing.

Advantageous polyvinyl alcohol fibers of this invention are capable of being processed on a commercial scale, using conventional meltblowing apparatus.

The stabilized polyvinyl alcohol polymers used in this invention may be manufactured in accordance with WO2022/008516 and WO2022/008521, the disclosures of which are incorporated into this specification by reference for all purposes.

The polyvinyl alcohol composition may be made by a method comprising the steps of introducing into a mixing reactor a polyvinyl alcohol polymer comprising homopolymeric polyvinyl alcohol or a blend thereof having a degree of hydrolysis in the range of 88 wt % to 98 wt % or more; where the mixing reactor comprises a blending chamber having a primary inlet, a primary outlet and at least two inter-engaging components extending between the primary inlet and primary outlet, the components being arranged to apply a shearing force to the polymer while the polymer is conveyed by the components from the inlet through a reaction zone to the outlet; one or more secondary inlets located downstream from the primary inlet for introducing reactants comprising a processing aid, a plasticizer and an optional reactive stabilizer to the chamber to form a reaction mixture; where the plasticizer is selected from the group disclosed above; wherein the reactive stabilizer when present is selected from the group consisting of: sodium stearate, potassium oleate, sodium benzoate, calcium stearate, stearic acid, dimethyl propionic acid, and mixtures thereof; wherein the blending chamber comprises a plurality of heated regions arranged so that the mixture is subjected to a temperature profile whereby the temperature increases from the inlet to the outlet; a secondary outlet located between the reaction zone and primary outlet arranged to allow removal of processing aid from the chamber; reacting the processing agent, plasticizer and polymer in the reaction zone to form plasticized polymer; and allowing the plasticized polymer to pass from the primary outlet.

Use of a reactive mixing apparatus, typically an extruder in accordance with this invention allows the processing aid and plasticizer to be reacted with the polyvinyl alcohol or blend thereof, without decomposition of the polymer followed by removal of all or most of the processing aid from the secondary outlet to give plasticized polyvinyl alcohol or a blend thereof.

Use of a reactive stabilizer may result in an advantageous reduction in the extent of degradation during melt processing. This allows homopolymeric polyvinyl alcohol having a high degree of hydrolysis, for example 88 wt % or higher to be processed to form fibers or pellets from which fibers may be formed by extrusion.

The reactive stabilizer may be used in an amount of about 0.1 wt % to about 5 wt %, for example about 0.1 wt % to about 3 wt %, for example 0.1 wt % to about 1.5 wt %, for example from about 0.2 wt % to about 0.5 wt %, for example about 0.25 wt %. The reactive stabilizers of this invention may decrease the extent of degradation of the polymer during processing. Homopolymeric polyvinyl alcohol has been difficult to process due to degradation at the high temperatures required. The liability of degradation has led to use of polyvinyl alcohol co-polymers with a consequent loss of engineering properties. This can be seen by UV spectral analysis of the amount of conjugation present in the polymer. Sodium benzoate has been found to be particularly effective.

Use of homopolymeric polyvinyl alcohol is particularly advantageous. Homopolymeric polyvinyl alcohol is manufactured by hydrolysis of homopolymeric polyvinyl acetate, the degree of hydrolysis being 90 wt % or more in embodiments of this invention. Polyvinyl alcohol co-polymers made by hydrolysis of polyvinyl acetate co-polymers have inferior properties compared to homopolymeric polyvinyl alcohol. Homopolymeric polyvinyl alcohol may exhibit advantageous properties.

Polyvinyl alcohol polymers of this invention may have high tensile strength and flexibility. The polyvinyl alcohol may be manufactured by hydrolysis of homopolymeric polyvinyl acetate, wherein the extent of hydrolysis is in the range from 88 wt % up to 98 wt %, for example 90 wt % to less than 95 wt %. A blend of two or more polyvinyl alcohol polymers may be employed, for example a blend of two polyvinyl alcohol polymers with a relatively high molecular weight and a relatively low molecular weight, respectively. A blend of polyvinyl alcohols with the same molecular weight and different degrees of hydrolysis can be combined. Blending different polyvinyl alcohol grades together enables the properties of the resultant polymer to be enhanced, for example melt strength.

For fiber production a blend of two polyvinyl alcohol polymers with a molecular weight in the range 14,000 to 22,000, a first polymer having a low degree of hydrolysis and a second polymer having a high degree of hydrolysis may be blended in a ratio of 40:60 to 60:40, for example about 50:50 by weight.

The blends of different molecular weight polymers employed are selected in accordance with the physical properties required in the finished product. This may require different molecular weight materials being used. Use of more than two different molecular weight polymers may be advantageous. The use of a single molecular weight polymer is not precluded.

Use of a blend may allow control of the viscosity of the polymer. Selection of a stabilizer in accordance with the present invention allows use of blends of a desired viscosity without a loss of other properties. Alternatively, use of a blend may permit use of polyvinyl alcohol with one or more stabilizers while maintaining viscosity or other properties to permit manufacture of pellets or films.

The processing aid is preferably water. Alternatively, the processing aid may comprise a mixture of water and one or more hydroxyl compound with a boiling point less than the boiling point or melting point of the plasticizer. Use of water is preferred for cost and environmental reasons. Two or more plasticizers may be employed. When a mixture of plasticizers is employed, a binary mixture may be preferred.

In an embodiment, the plasticizer may be selected from the group consisting of: diglycerol, triglycerol, xylose, D-mannitol, triacetin, dipentaerythritol, 1,4-butanediol, 3,3-dimethyl-1,2-butanediol, and caprolactam.

The total amount of plasticizer in the formulation may be from about 15 wt % to about 30 wt %.

Polymer compositions and fibers of the present invention may not include any or any substantial amount of a water-soluble salt, oil, wax or ethylene homopolymer or copolymer.

The method of this invention provides many advantages. The method allows formation of thermally processable polyvinyl alcohol which can be used to create economical fibers that are highly functional while eliminating plastic pollution. Polyvinyl alcohol is water-soluble, non-toxic to the environment and inherently biodegradable. Hydrophilic polymers, for example, polyvinyl alcohol degrade environmentally faster than hydrophobic polymers and do not show bioaccumulation. Thermoplastic polyvinyl alcohol can be mechanically recycled into pellets for repeated use.

Homopolymeric polyvinyl alcohol fibers of this invention provide many advantages in comparison to previously available polyvinyl alcohol containing fibers. The fibers of this invention and products made from these fibers exhibit improved tensile strength, barrier properties, water solubility and biodegradability. Homopolymeric polyvinyl alcohol fibers may unexpectedly exhibit all of these properties. In comparison, copolymers have only been able to compromise and provide one or more of these properties at the expense of other properties. The fibers and products of the present invention have a desirable monomaterial structure which does not suffer from this disadvantage.

The fibers of this invention may exhibit advantageous chemical resistance, particularly to alcohols, acids and alkalis.

Meltblown fibers of this invention may have an advantageous smaller diameter. Fibers having a smaller diameter have a greater surface area which may be advantageous for air filtration, for example in face masks. Finer fibers may also be softer in texture. Furthermore, finer fibers may also have an increased rate of biodegradation after use.

According to a second aspect of the present invention there is provided meltblown homopolymeric polyvinyl alcohol fiber having a degree of hydrolysis of 88 wt % to 98 wt % or greater. The fiber may be manufactured in accordance with the first aspect of the present invention.

According to a third aspect of the present invention, there is provided a meltblown non-woven fiber product comprising fibers of homopolymeric polyvinyl alcohol having a degree of hydrolysis of 88 wt % to 98 wt % or greater. The product may be made in accordance with the method of the first aspect of the present invention.

A non-woven product is defined by ISO9092 as an engineered fibrous assembly, primarily planar, which has been given a designed level of structural integrity by physical and/or chemical means, excluding weaving, knitting or paper making.

The areal density may be about 50 gm⁻², dependent on the application, for example single or multiple use applications. In embodiments, the areal density may be about 60 gm⁻². Non-woven fabrics having this density may be employed for manufacture of flushable wipes.

The following processing parameters may be employed. The die temperature may be in the range 200° C. to 230° C. An optimal die temperature may be 220° C. Melt breaks may be observed at higher temperatures. The air flow volume may be in the range 2,000 to 7,000 1 min⁻¹, for example 5,900 to 6,900 1 min⁻¹. A higher air flow of 7,000 1 min⁻¹ may allow greater drawing of the polymer stream and may allow the average filament diameter to be reduced from 14.1 μm to 12.6 μm. The die air temperature may be in the range 200 to 280° C., for example 245 to 280° C. A preferred air temperature may be 220 to 240° C. An increase to a higher die air temperature may result in more frequent melt breaks. A die-to-collector distance of 0.1 to 0.25 m, for example 0.24 m may be employed. Meltblown polyvinyl alcohol nonwoven fabrics of this invention find many applications which utilize the unique properties of homopolymeric polyvinyl alcohol. Percentages and other quantities referred to in this specification are by weight unless stated otherwise and are selected from any ranges quoted to total 100%.

The invention is further described by means of example but not in any limitative sense, with reference to the accompanying drawings.

### EXAMPLES

In embodiments of the present invention the following polyvinyl alcohol (PVOH) homopolymer compositions may be employed.

Polymer Composition A

| | |
|---|---|
| PVOH; degree of hydrolysis 98%; low viscosity | 35.97% |
| PVOH; degree of hydrolysis 89%; low viscosity | 35.97% |
| Trimethylol propane | 14.37% |
| Sodium benzoate | 0.21% |
| Glycerol | 4.29% |
| Water | 9.20% |

Polymer Composition B

| | |
|---|---|
| PVOH; degree of hydrolysis 99%; high viscosity | 7.193% |
| PVOH; degree of hydrolysis 98%; low viscosity | 64.737% |
| Trimethylol propane | 14.37% |
| Sodium benzoate | 0.21 |
| Glycerol | 4.29% |
| Water | 9.20% |

Polymer Composition C

| | |
|---|---|
| PVOH; degree of hydrolysis 98%; low viscosity | 35.87% |
| PVOH; degree of hydrolysis 89%; low viscosity | 35.87% |
| Di-pentaerythritol | 6.21% |
| Triacetin | 12.41% |
| Sodium benzoate | 0.25% |
| Water | 9.39% |

Polymer Composition D

| | |
|---|---|
| PVOH; degree of hydrolysis 98%; low viscosity | 22.61% |
| PVOH; degree of hydrolysis 97%; medium viscosity | 52.76% |
| Dipentaerythritol | 4.99% |
| Sodium benzoate | 0.25% |
| Triacetin | 10.00% |
| Water | 9.39% |

Polymer Composition E

| | |
|---|---|
| PVOH; degree of hydrolysis 98%; low viscosity | 25.20% |
| PVOH; degree of hydrolysis 98%; low viscosity | 5.20% |
| PVOH; degree of hydrolysis 89%; low viscosity | 25.21% |
| Dipentaerythritol | 5.00% |
| Triacetin | 10.00% |
| Water | 9.39% |

Polymer Composition F

| | |
|---|---|
| PVOH; degree of hydrolysis 98%; low viscosity | 27.33% |
| PVOH; degree of hydrolysis 98%; low viscosity | 27.33% |
| PVOH; degree of hydrolysis 89%; low viscosity | 27.33% |
| Dipentaerythritol | 8.00% |
| Methyl pentanediol | 5.50% |
| Glycerol | 4.50% |

Polymer Composition G

| | |
|---|---|
| PVOH; degree of hydrolysis 98%; low viscosity | 72.45% |
| PVOH; degree of hydrolysis 99%; high viscosity | 9.20% |
| Dipentaerythritol | 7.95% |
| Methyl pentanediol | 5.63% |
| Glycerol | 4.50% |
| Sodium benzoate | 0.27% |

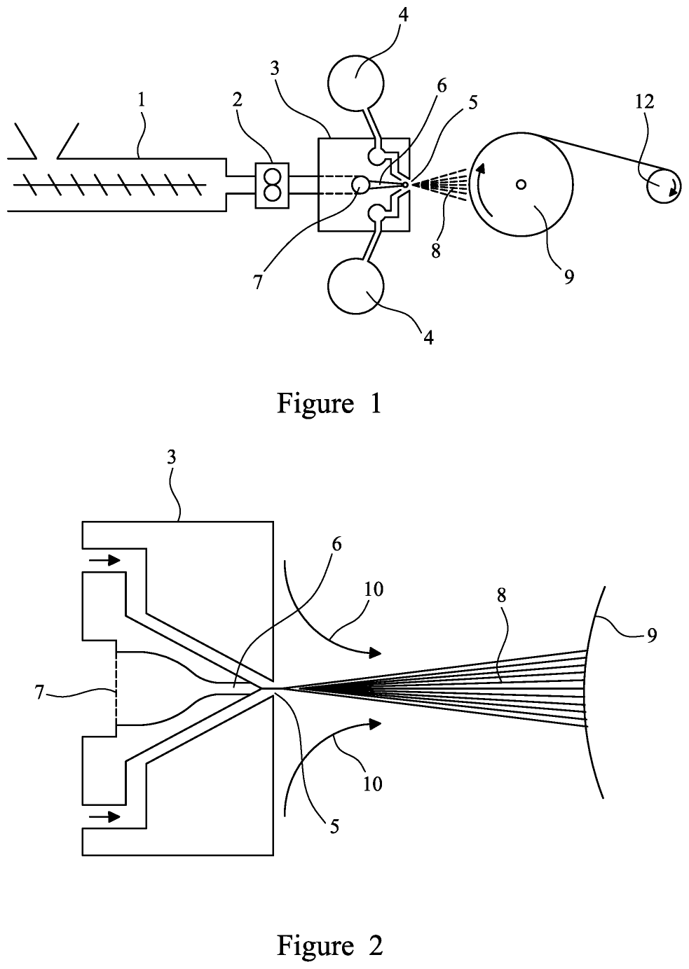

FIGS. 1 and 2 illustrate meltblowing apparatus used in accordance with the present invention. An extruder (1) supplies molten polyvinyl alcohol composition to a gear pump (2) which feeds the polymer to a die (3). Air manifolds (4) supply primary high velocity air flows to the die outlet (5) so that the primary air flows surround the die outlet (6) of the polymer feed (7). The primary air flows create a stream of molten fibers (8) directed towards a rotating cylindrical collector (9). Secondary air flows (10) serve the cool the streams of molten polymer fibers, promoting solidification of the polymer streams as they contact the collector (9) to form a solidified non-woven web (11). The solidified web (11) is drawn from the collector and wound upon a rotary winder (12).

### Example 1

Meltblown polyvinyl alcohol fibers were extruded using the following parameters. Polymer composition A was employed.

Meltblowing Parameters

| Parameters | | |
|---|---|---|
| Extruding zone 1 | 180° | C. |
| Extruding zone 2 | 200° | C. |
| Extruding zone 3 | 205° | C. |
| Die temperature | 210-220° | C. |
| Air temperature | 240-280° | C. |
| Air flow volume | 6900 | l · min⁻¹ |
| Die-to-collector distance | 0.1-0.3 | m |
| Extrusion speed | 6-16 | rpm |
| Die hole diameter | 0.25 | mm |
| Air angle | 45° | |
| Air knife gap | 0.7-1.4 | mm |

An advantageous polyvinyl alcohol polymer for formation of melt blown fabrics had a degree of hydrolysis of 94%, using trimethylolpropane as a plasticizer with additional glycerol. The resultant meltblown fabrics had an areal density of 60.88 g/m², thickness of 0.51 mm; filament diameter of 12.61 μm; air impermeability at 200 Pa of 3,5361·min⁻² s⁻¹ and tensile strength, MD of 0.44 1/25 mm, before thermal bonding.

A significant proportion (65%) of the filament diameters was measured between 5 and 14 μm with an average filament diameter of 12.6 μm. The air velocity was 6,900 1·min⁻¹ at an air flow of 6,200 1·min⁻¹, a significant proportion of the filament diameters was between 10 and 14 μm with an average filament diameter of 14.12 μm. Higher air velocity allowed attenuation of the polymers into fine filaments.

What is claimed is:

1. A method of manufacture of a nonwoven product comprising polyvinyl alcohol fibers,
the method comprising the steps of
providing a polyvinyl alcohol composition comprising homopolymeric polyvinyl alcohol having a degree of hydrolysis of 88% to 98% or greater and a weight average molecular weight in the range from 14,000 to 35,000;
a plasticizer selected from the group consisting of: diglycerol, triglycerol, fructose, ribose, xylose, D-mannitol, triacetin, pentaerythritol, dipentaerythritol, methyl pentanediol, 1,2-propanediol, 1,4-butanediol, 2-hydroxy-1,3-propanediol, 3-methyl-1,3-butanediol, 3,3-dimethyl-1,2-butanediol, polyethylene glycol 300, polyethylene glycol 400, alkoxylated polyethylene glycol, caprolactam, tricyclic trimethylolpropane formal, rosin esters, erucamide, and mixtures thereof; and
an optional stabilizer selected from the group consisting of sodium stearate, potassium oleate, sodium benzoate, calcium stearate, stearic acid, dimethyl pentane diol, propionic acid, and mixtures thereof;
melting the composition at a temperature from 190° C. to 240° C. to form a molten polymer;
wherein the molten polymer is meltblown by the steps of:
extrusion of the molten polymer through a die having a spinneret to form molten fibers of the polymer;
the fibers being blown from the die and attenuated by a flow of heated air to form attenuated molten fibers, the attenuated fibers being deposited on a moving collector and allowed to solidify to form a melt blown nonwoven fiber web.

2. A method as claimed in claim 1, wherein the degree of hydrolysis is 90 to 95%.

3. A method as claimed in claim 2, wherein the degree of hydrolysis is 93 to 95%.

4. A method as claimed in claim 1, wherein the molecular weight of the homopolymeric polyvinyl alcohol is in the range of 14,000 to 22,000.

5. A method as claimed in claim 4, wherein the molecular weight of the homopolymeric polyvinyl alcohol is in the range of 15,000 to 20,000.

6. A method as claimed in claim 5, wherein the molecular weight of the homopolymeric polyvinyl alcohol is in the range of 16,000 to 20,000.

7. A method as claimed in claim 6, wherein the composition is melted at a temperature in the range from 220° C. to 230° C.

8. A method as claimed in claim 1, wherein the polyvinyl alcohol composition has a melt flow index in the range of 30 to 80 g/10 min.

9. A method as claimed in claim 8, wherein the polyvinyl alcohol composition has a melt flow index in the range of 50 to 75 g/10 min.

10. A method as claimed in claim 9, wherein the polyvinyl alcohol composition has a melt flow index in the range of 70 to 75 g/10 min.

11. A method as claimed in claim 1, wherein the molten polymer is extruded from a die having a temperature in the range of 200° C. to 220° C.

12. A method as claimed in claim 1, wherein the air temperature at the die is in the range of 200° C. to 280° C.

13. A method as claimed in claim 1, wherein the air pressure at the die is 50 kPa to 110 kPa.

14. A method as claimed in claim 1, wherein the fiber diameter is in the range of 12 μm to 15 μm.

15. A meltblown polyvinyl alcohol fiber made in accordance with claim 1.

16. A meltblown nonwoven fabric comprising homopolymeric polyvinyl alcohol having a degree of hydrolysis of 88 wt % to 98 wt % or greater.

17. A meltblown nonwoven fabric consisting of homopolymeric polyvinyl alcohol having a degree of hydrolysis of 88 wt % to 98 wt % or greater.

18. A meltblown nonwoven homopolymeric polyvinyl alcohol fabric made by the method of claim 1.

19. A product incorporating a meltblown fabric as claimed in any of claims 16 to 18, wherein the product is selected from the group consisting of dry wipes, hygiene top sheets and core wraps, filters, face masks and personal protective equipment.
